(19) United States
(12) Patent Application Publication
(10) Pub. No.: US 2015/0091398 A1
(43) Pub. Date: Apr. 2, 2015

(54) ELECTRIC MACHINE WITH IN SLOT COOLING SYSTEM

(71) Applicant: Remy Technologies, LLC, Pendleton, IN (US)

(72) Inventor: Michael D. Bradfield, Anderson, IN (US)

(21) Appl. No.: 14/044,500

(22) Filed: Oct. 2, 2013

(51) Int. Cl. H02K 9/19; H02K 15/14

(52) U.S. Cl. CPC H02K 9/19; H02K 15/14
USPC 310/54; 29/596

(57) ABSTRACT

An electric machine that includes a stator core having at least one slot and a winding in the slot. An elongate cooling conduit defines at least one projecting bend that is positioned in the slot. The projecting bend has first and second axially extending legs and an intermediate section. Coolant is conveyed through a first axial end opening of the slot within the first leg and then sequentially conveyed through the intermediate section and out the first axial end opening within the second leg. The projecting bend is in thermal communication with at least one of the winding and the stator core. A method of manufacture is also disclosed and may include bending a conduit having a uniform wall thickness and cross-section to form a plurality of projecting bends. The method may also include simultaneously inserting the projecting bends into respective slots from one end of the stator core.

### BACKGROUND

The present invention relates to electric machines and, more particularly, to cooling systems for electric machines.

Electric machines may take the form of a motor, a generator or a motor/generator capable of selectively operating as either a motor or a generator. When operating as a motor, electrical current is input into the electric machine to generate a mechanical torque. When operating as a generator, mechanical torque is input into the electric machine to generate electrical current. Electric machines include a stator and a rotor which rotates relative to the stator.

In some applications, electric machines require the use of a cooling system to remove excess heat from the electric machine generated during operation. Various approaches are known for removing excess heat. For example, some electric machines are air cooled with a fan directing a flow of air across the electric machine to remove heat. Another common type of cooling system for electric machines is a liquid coolant system wherein a circulating liquid coolant is used to remove heat from the electric machine.

The type and application of the electric machine will be determining factors in the location and quantity of the heat generated by the electric machine. For many electric machines, the stator windings will be responsible for generating the majority of the heat during operation of the electric machine. In such electric machines, it is generally desirable to cool the stator either by directly removing heat from the stator windings or by removing heat from the stator core.

One common method of removing heat from the stator core with a liquid coolant system is to mount the stator in an exterior housing commonly referred to as a “water jacket.” The exterior housing which forms the “water jacket” includes a plurality of liquid coolant passages and surrounds and directly engages the stator core. A liquid coolant is circulated through the housing passages to remove heat from the housing. The housing thereby removes heat from the stator core and, consequently, the stator windings.

Although the various known methods of cooling electric machines can be effective, improved cooling systems remain desirable.

### SUMMARY

The present invention provides an improved liquid coolant system for an electric machine.

The invention comprises, in one form thereof, an electric machine that includes a rotor rotatable about an axis and a stator operably coupled with the rotor wherein the stator includes a stator core and at least one winding. The stator core defines at least one slot wherein the winding extends axially within the slot and wherein the slot defines a first axial end opening. The electric machine also includes an elongate cooling conduit adapted to convey a liquid coolant therein. The conduit has at least one projecting bend positioned in the at least one slot wherein the projecting bend has first and second axially extending legs and an intermediate section connecting the first and second legs. The first leg is positioned to convey coolant into the slot through the first axial end opening wherein the coolant is sequentially conveyed within the projecting bend through the first leg, the intermediate section and then the second leg. The second leg conveys the coolant out of the slot through the first axial end opening and the projecting bend is in thermal communication with at least one of the winding and the stator core.

In some embodiments, the projecting bend is advantageously configured to be insertable into the slot through the first axial end opening. In other embodiments, the at least one slot may also define a second axial end opening opposite the first axial end opening with the projecting bend extending axially within the slot to or beyond a location proximate the second axial end opening. In still other embodiments, the projecting bend may be displaced radially relative to the winding. Still other embodiments may employ other features, for example, the conduit can be secured relative to the stator core by engagement of the at least one projecting bend with the stator core. Alternatively, or additionally, the intermediate section may define a pair of axially extending conduit segments.

In yet another embodiment, the at least one slot defines a second axial end opening opposite the first axial end opening and the electric machine further comprises a second elongate cooling conduit adapted to convey a liquid coolant therein. The second conduit has at least one opposing projecting bend positioned in the at least one slot wherein the opposing bend has third and fourth axially extending legs and a second intermediate section connecting the third and fourth legs. The third leg is positioned to convey coolant into the slot through the second axial end opening with the coolant being sequentially conveyed within the opposing bend through the third leg, the intermediate section and then the fourth leg. The fourth leg conveys the coolant out of the slot through the second axial end opening and the opposing bend is in thermal communication with at least one of the winding and the stator core.

In an embodiment employing such a second conduit with an opposing bend the projecting bend may extend axially within the slot from the first axial end opening to proximate a midway point between the first and second axial end openings with the opposing projecting bend extending from the second axial end opening within the slot to proximate the midway point. Alternatively, the projecting bend and the opposing projecting bend may both extend within the slot for a distance substantially equivalent to the axial distance between the first and second axial end openings.

In still other embodiments, the at least one slot is a plurality of slots with each of the slots defining a first axial end opening and an opposite second axial end opening and wherein the at least one winding includes a plurality of windings with at least one of the plurality of windings extending axially within each of the plurality of slots. In such an embodiment, the elongate cooling conduit advantageously defines a plurality of projecting bends with each of the projecting bends having first and second axially extending legs and an intermediate section connecting the first and second legs. Each of the projecting bends is disposed in a respective one of the plurality of slots wherein the first leg is positioned to convey coolant into the one slot through the first axial end opening, the coolant being sequentially conveyed within the projecting bend through the first leg, the intermediate section and then the second leg, with the second leg conveying the coolant out of the one slot through the first axial end opening.

In such an embodiment having a plurality of slots, the elongate conduit forming the plurality of projecting bends may be a unitary length of conduit having a substantially uniform wall thickness and substantially uniform circumferential dimensions.

The invention comprises, in another form thereof, an electric machine that includes a rotor rotatable about an axis and a stator operably coupled with the rotor. The stator includes a stator core which is formed out of a stacked plurality of sheet metal laminations and defines a plurality of slots. Each of the slots has an axial length and first and second axial end openings located at opposite axial ends of the slot. The stator further includes a plurality of windings wherein at least one of the plurality of windings extends axially within each of the plurality of slots. The electric machine also includes an elongate cooling conduit adapted to convey a liquid coolant therein. The conduit defines a plurality of projecting bends wherein each of the projecting bends has first and second axially extending and substantially parallel legs and an intermediate section connecting the first and second legs. Each of the projecting bends is disposed in a respective one of the plurality of slots wherein the first leg is positioned to convey coolant into the one slot through the first axial end opening, the coolant being sequentially conveyed within the projecting bend through the first leg, the intermediate section and then the second leg, with the second leg conveying the coolant out of the one slot through the first axial end opening. The projecting bend is positioned radially adjacent the at least one winding disposed in the slot and the projecting bend is also in thermal communication with at least one of the stator core and the at least one winding disposed in the slot. The elongate conduit forming the plurality of projecting bends is a unitary length of conduit having a substantially uniform wall thickness and substantially uniform circumferential dimensions.

In some embodiments, the plurality of projecting bends are advantageously configured to be simultaneously and respectively insertable into the plurality of slots through the first axial end openings of the slots. Alternatively or additionally, the conduit can be secured relative to the stator core by engagement of the plurality of projecting bends with the stator core.

Some embodiments may also include a second elongate cooling conduit adapted to convey a liquid coolant therein. The second conduit has a plurality of opposing projecting bends each of which is positioned in a respective one of the plurality of slots with each of the opposing bends having third and fourth axially extending legs and a second intermediate section connecting the third and fourth legs. The third leg is positioned to convey coolant into the slot through the second axial end opening with the coolant being sequentially conveyed within the opposing bend through the third leg, the intermediate section and then the fourth leg. The fourth leg conveys the coolant out of the slot through the second axial end opening with the opposing bend being in thermal communication with at least one of the stator core and the least one of the winding disposed in the slot.

The invention comprises, in still another embodiment thereof, a method of manufacturing an electric machine wherein the method includes providing a stator core with a plurality of slots and providing a plurality of windings and installing at least one winding in each of the plurality of slots. The method also includes forming a plurality of projecting bends in an elongate conduit and positioning each of the projecting bends in one of the plurality of slots wherein each projecting bend has first and second axially extending and substantially parallel legs and an intermediate section connecting the first and second legs. The first leg is positioned to convey coolant into the slot proximate a first axial end of the stator core, the coolant being sequentially conveyed within the projecting bend through the first leg, the intermediate section and then the second leg, with the second leg conveying the coolant out of the slot proximate the first axial end of the stator core. The projecting bend is in thermal communication with at least one of the winding and the stator core. The method additionally includes operably coupling the stator assembly with a rotor assembly.

In some embodiments, the step of forming a plurality of projecting bends in an elongate conduit includes providing a continuous and unitary conduit having a uniform wall thickness and uniform cross-sectional shape and bending the conduit to form the plurality of projecting bends.

In some embodiments, the step of positioning each of the projecting bends in one of the plurality of slots includes simultaneously inserting each of the projecting bends into a respective one of the plurality of slots from the first axial end of the stator core.

In some embodiments, the step of positioning each of the projecting bends in one of the plurality of slots comprises securing the elongate conduit to the stator core by engaging the projecting bends with the stator core.

### BRIEF DESCRIPTION OF THE DRAWINGS

The above mentioned and other features of this invention, and the manner of attaining them, will become more apparent and the invention itself will be better understood by reference to the following description of embodiments of the invention taken in conjunction with the accompanying drawings, wherein:

FIG. 1 is a schematic cross sectional view of an electric machine having an in slot cooling system.

FIG. 2 is a schematic view of a cooling tube being inserted in a stator core.

FIG. 3 is a schematic view of the cooling tube and stator core of FIG. 2 after insertion of the cooling tube.

FIG. 4 is a schematic side view of an alternative cooling tube configuration installed in a stator core.

FIG. 5 is a schematic side view of another alternative cooling tube configuration installed in a stator core.

FIG. 6 is a schematic side view of another alternative cooling tube configuration installed in a stator core.

FIG. 7 is a schematic partial end view of an electric machine with an in slot cooling system.

FIG. 8 is a schematic partial end view of an electric machine with an alternative cooling tube configuration.

FIG. 9 is a schematic partial end view of an electric machine with another alternative cooling tube configuration.

FIG. 10 is a schematic partial end view of an electric machine with another alternative cooling tube configuration.

FIG. 11 is a schematic partial end view of an electric machine with another alternative cooling tube configuration.

FIG. 12 is a schematic view showing the coolant flow for an electric machine having an in slot cooling system.

FIG. 13 is a schematic view showing the coolant flow for an electric machine having an alternative in slot cooling system.

FIG. 14 is a schematic view showing the coolant flow for an electric machine having another alternative in slot cooling system.

FIG. 15 is a schematic view showing the coolant flow for an electric machine having another alternative in slot cooling system.

FIG. 16 is a schematic view showing the coolant flow for an electric machine having another alternative in slot cooling system.

Corresponding reference characters indicate corresponding parts throughout the several views. Although the exemplification set out herein illustrates embodiments of the invention, in several forms, the embodiments disclosed below are not intended to be exhaustive or to be construed as limiting the scope of the invention to the precise forms disclosed.

### DETAILED DESCRIPTION

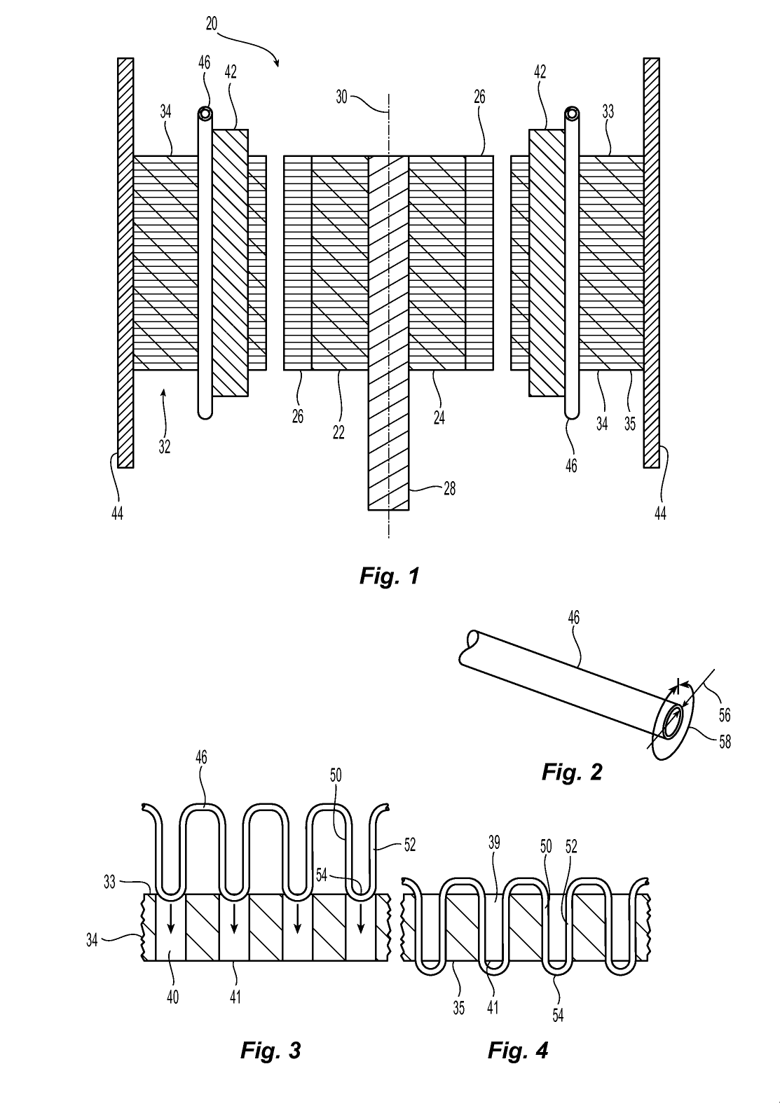

An electric machine 20 with an in slot cooling system is schematically depicted in FIG. 1. Electric machine 20 includes a rotor assembly 22 having a rotor core 24 mounted on a shaft 28 and rotatable about axis 30. Rotor core 24 is formed out of a plurality of stacked sheet metal laminations and defines a plurality of radially projecting poles 26.

Electric machine 20 also includes a stator assembly 32 having a stator core 34 which encircles rotor assembly 22. Stator core 34 is formed out of a plurality of sheet metal laminations 38 and defines a plurality of radially inwardly projecting teeth 36. Stator teeth 36 define a plurality of axially extending slots 40 therebetween. Windings 42 are disposed in the slots 40. Stator assembly 32 is mounted within a housing 44 with the radially outer surface of stator core 34 engaging the radially inner surface of housing 44. It is noted that the illustrated embodiment has concentrated windings, however, alternative embodiments could employ distributed windings. A stator with distributed windings generally has a more complex winding pattern and the area where the end turns project beyond the axial end of the stator core is more congested with wiring. The difference between distributed and concentrated windings is well-known to those having ordinary skill in the art.

In the illustrated embodiment, electric machine 20 is a switched reluctance motor, however, alternative embodiments of the invention may be employed with other types of electric machines. Typically, electric machines have stators which circumscribe the rotor, however, other embodiments could employ a stationary stator that is centrally disposed with the rotatable rotor encircling the stator.

Electric machine 20 also includes a cooling system which circulates a liquid coolant, such as a water, ethylene, glycol mixture or other suitable liquid coolant, through one or more elongate cooling conduits to remove excess heat from stator assembly 32. In the embodiment of FIGS. 1-4, electric machine 20 includes a single elongate conduit 46. Conduit 46 defines a projecting bend 48 for each slot 40 in stator core 32.

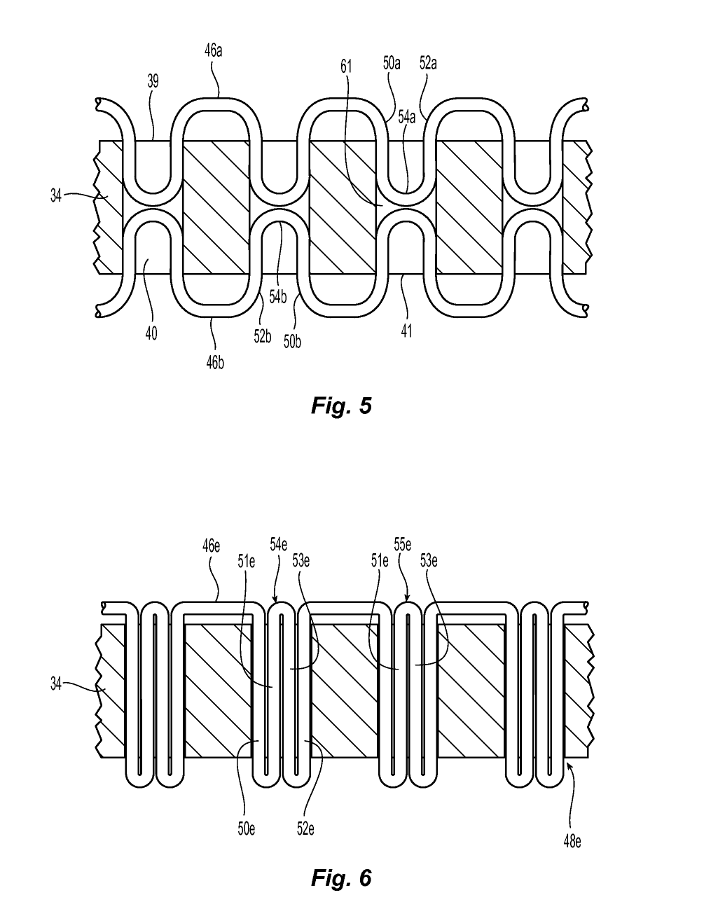

As can be understood with reference to FIGS. 3 and 4, projecting bends 48 each include first and second axially extending legs 50, 52 which are connected by an intermediate section 54. FIGS. 3 and 4, as well as FIGS. 5-7 discussed below, schematically depict the stator core and cooling conduits in a linear configuration instead of their actual configuration which encircles axis 30 to more clearly depict the manner in which cooling conduits are inserted into stator slots 40.

In the illustrated embodiment, when electric machine 20 is a relatively large switch reluctance motor the stator slot widths can be sufficiently large to allow conduit 46 to be formed out of commercially available copper tubing having a nominal outside diameter of 6 or 8 mm. A continuous and unitary length of copper tubing is bent to form a plurality of projecting bends 48 whereby each of the bends 48 can be inserted into one of the stator slots 40.

Stator slots 40 each define a first axial end opening 39 on one axial end 33 of stator core 34 and a second axial end opening 41 on the opposite axial end 35 of stator core 34. The projecting bends 48 are configured to be inserted through one of the axial end openings of slots 40. In the embodiment of FIGS. 1-4, projecting bends 48 are each simultaneously inserted into their respective slot 40 through axial end openings 39, which are all on the same axial end of stator core 34, when installing conduit 46.

As a result of this configuration, for each of projecting bends 48, first leg 50 will convey coolant into its respective slot 40 through first axial end opening 39, the coolant is then sequentially conveyed within bend 48 through first leg 50, intermediate section 54 and then second leg 52. Second leg 52 conveys the liquid coolant out of slot 40 through the same axial end opening 39 that first leg 50 conveyed the coolant into the slot 40.

Within slot 40, projecting bend 48 is in thermal communication with at least one of stator winding 42 and stator core 34 whereby excess heat from one or both of stator winding 42 and stator core 34 can be transferred to conduit 46 and then to the liquid coolant within conduit 46. The coolant will then be conveyed through conduit 46 to an external portion of the cooling system which will include a heat-exchanger, e.g., a radiator, or other suitable means for discharging the excess heat. Advantageously, projecting bend 48 is in direct contact with both stator core 34 and stator winding 42 within slot 40 to promote the efficient transfer of heat.

In this regard, it is noted that conduit 46 starts out as a continuous and unitary length of copper tubing having a round cross section as seen in FIG. 2. After the tubing is bent to form projecting bends 48 and both bends 48 and stator windings 42 are installed in slots 40, the originally round tubing forming conduit 46 will be slightly flattened as it is compressed within slot 40. This advantageously enhances the contact between conduit 46 and stator core 34 and windings 42 to thereby promote the transfer of thermal energy and also secures bends 48 within slots 40. While the illustrated embodiments employ round conduits that are slightly deformed during installation, alternative embodiments could employ conduits with alternative cross sectional shapes and/or shapes that are not altered during the installation process.

In this regard, it is also noted that conduit 46 shown in FIGS. 1-4 is a unitary length of conduit having a substantially uniform wall thickness 56 and a substantially uniform circumferential dimension 58 even though it is bent from its original configuration, e.g., coiled or straight, and the cross sectional shape is deformed during installation in electric machine 20. In other words, conduit 46 starts out as a length of continuous and unitary tubing and is subsequently deformed during installation but this does not remove material from the tube to reduce the thickness of the wall or the circumferential extent of the tube although the interior volume of the tube may be reduced by the deformation of the tube during installation. This stands in contrast to forming a custom tube that originally has distinct sections with different wall thicknesses and/or circumferential dimensions as might occur if conduit were formed by piecing together linear lengths of tubes with elbows and other fittings. It is noted that while such piecing together of a conduit will generally be undesirable, it would be possible to form a conduit 46 using such a process. A unitary length of tubing, as used herein, is a length of tubing that has not been pieced together by connecting originally separate lengths of tubing with joints or connectors. In this regard, it is noted that commercially available tubing, such as copper tubing, is typically provided in unitary lengths of tubing having a substantially uniform wall thickness and a substantially uniform circumferential dimension.

The use of projecting bends 48 within slots also provides several additional advantages. The material used to form conduit 46 will need to efficiently transfer heat from the stator assembly to the liquid coolant. Many metal materials, e.g., copper, are well suited for transferring heat. Metal materials, however, are also typically good conductors of electricity and capable of having an electrical current or voltage potential induced therein by the operation of electric machine 20 if the metal material is positioned in slot 40. If induced voltage is generated in a coolant tube positioned in slot 40, this can possibly negatively impact the performance of electric machine 20. The configuration of projecting bends 48 reduces such negative impacts by employing oppositely extending legs 50, 52 connected by intermediate section 54.

More specifically, by employing a projecting bend with a first leg 50 and a second leg 52 that extend substantially parallel to each other in the same slot 40 and having an intermediate section 54 of the tubing connect the two legs wherein the tubing forming first leg 50, second leg 52 and intermediate section 54, is a continuous electrical conductor, the induced voltage in the projecting bend minimized due to the opposing polarity of the induced voltage in the first and second legs 50, 52. As a result, magnetically induced losses are minimized and the performance of electric machine 20 is enhanced.

The use of conduit 46 also provides manufacturing advantages. When conduit 46 is formed out of a unitary length of tubing the ability to insert conduit 46 from one axial end into the slots eliminates the need to form multiple tube joints that would be necessary if individual tubes were routed through each slot conveying the liquid into one end and out the other end of the slots. Furthermore, the tight fit of bends 48 within slots 40 secures conduit 46 in place and eliminates the need to use clamps, brazing or other methods to secure the conduit.

FIG. 8 shows a partial axial end view of an electric machine 20 and one potential arrangement of conduit 46 and windings 42 within slot 40. In the arrangement of FIG. 8, conduit 46 is displaced radially relative to windings 42 and engages stator core 34 but has only minimal if any direct engagement with windings 42. In this embodiment, conduit 46 is secured relative to stator core 34 by engagement of projecting bends 48 with stator core 34. It is further noted that a thin electrically insulating member 60 is positioned about the outer periphery of winding 42 except for that portion of windings 42 that face the radially inner opening of slot 40. Members 60 are often called wedges and are used to protect windings 42 from abrasion against stator core 34 during the insertion of windings 42 and thereby prevent electrical communication between windings 42 and stator core 34. The use of wedges 60 is well-known to those having ordinary skill in the art. In this regard, it is noted that such wedges 60 are considered to be part of windings 42 herein and direct contact between conduit 46 and windings 42 can be achieved by engaging conduit 46 with wedge 60.

Returning to FIG. 4, it is noted that when a single conduit 46 is employed, it will generally be desirable for the projecting bends 48 of conduit 46 to extend axially within slot 40 from the first axial end opening 39 to or beyond a location proximate the second axial end opening 41 whereby conduit 46 can provide cooling for substantially the entire axial length of slot 40. In the embodiment of FIG. 4, bends 48 project slightly beyond axial end openings 41.

Various other arrangements of projecting bends and windings can also be employed. For example, instead of positioning the projecting bend at the back of slot 40 as depicted in FIG. 8, i.e., displacing bend 48 radially outward of windings 42, the projecting bend could be positioned between the windings or at the inner diameter of slot 40. Several additional configurations are discussed below.

It is also noted that conduit 46 may be inserted into slot 40 either before or after windings 42. Generally, the order of insertion which provides for the most efficient method of assembly will be determined by the arrangement of the conduit 46 and winding 42 in slot 40. Moreover, some embodiments include multiple conduits inserted into a single slot and in such embodiments it may be desirable to insert a conduit, then the winding and then an additional conduit.

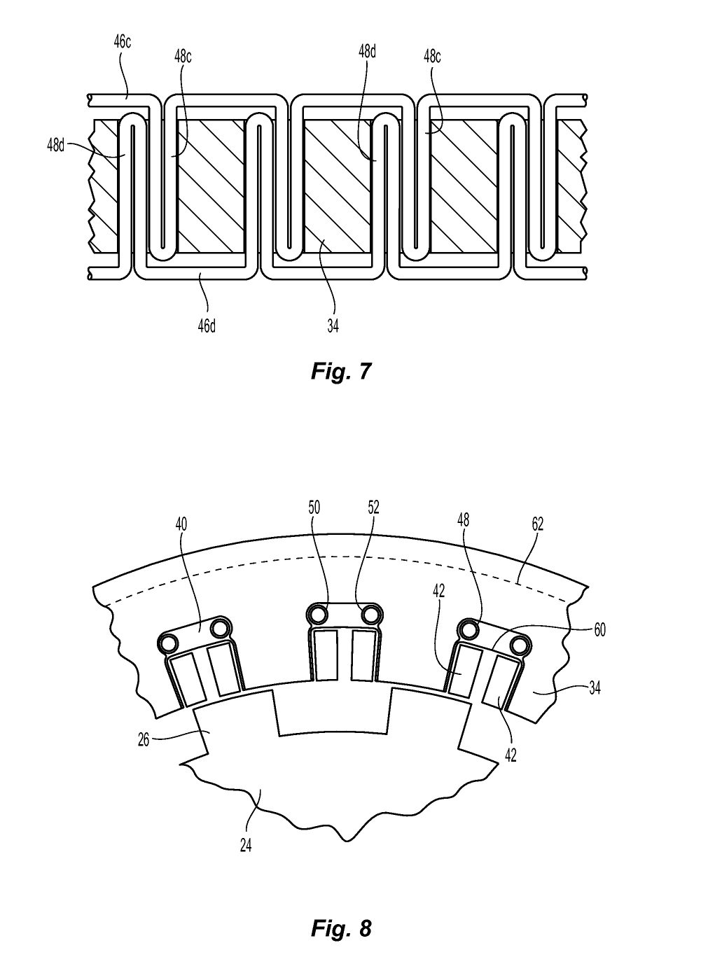

FIGS. 5 and 7 illustrate embodiments which include two elongate conduits having projecting bends wherein the projecting bends of the two conduits are inserted into the slots from opposite axial ends of the stator core. In FIG. 5, a first conduit 46a has a plurality of projecting bends 48a with first and second legs 50a, 52a and intermediate sections 54a that are inserted into slots 40 through first axial end openings 39. A second conduit 46b has a plurality of projecting bends 48b with first and second legs 50b, 52b and intermediate sections 54b. The projecting bends 48a, 48b function in the same manner as bends 48 described above with reference to conduit 46. The difference being that bends 48a, 48b extend axially only halfway through slot 40 and meet proximate the axial midpoint 61 of slot 40. In other words, projecting bends 48a extend axially within slots 40 from first axial end openings 39 to a location proximate midway point 61 between first and second axial end openings 39, 41 and opposing projecting bends 48b extend from second axial end openings 41 with slot 40 to a location proximate midway point 61.

FIG. 7 illustrates an embodiment wherein conduits 46c and 48d respectively define projecting bends 48c, 48d. Bends 48c, 48d enter slot 40 from opposite axial ends of slot 40, are circumferentially offset from each other, and extend for substantially the entire axial length of slot 40. In other words, both projecting bend 48c and projecting bend 48d extend within slot 40 for a distance substantially equivalent to the axial distance between first and second axial end openings 39, 41 of slot 40.

FIG. 6 illustrates another embodiment wherein a single conduit 46e has projecting bends 48e that are inserted through axial end openings 39 of slots 40. Projecting bends 48e differ from bends 48 in that bends 48e include a second pair of legs. As seen in FIG. 6, conduit 46e defines projecting bends 48e that each include first and second legs 50e, 52e and an intermediate section 54e with intermediate sections 54e each defining a pair of axially extending conduit segments 51e, 53e which are connected by a turn segment 54e.

FIGS. 8-12 provide partial axial end views illustrating several different arrangements of the projecting bends and windings within the stator slots. As mentioned above, FIG. 8 shows a projecting bend 48 wherein the bend 48 is displaced radially outwardly of windings 42. Also shown in FIG. 8 is a dashed line 62. Line 62 represents where the radial outermost edge of stator core 34 would be if no cooling conduits were inserted in slots 40 and a water jacket was used to cool stator assembly 32 instead. As can be seen, positioning cooling conduits in slots 40 requires that the outer diameter of the stator core be enlarged to account for the radial enlargement of slots 40. Positioning cooling conduits in slots 40, however, also allows the coolant passages to be omitted from housing 44. Thus, the outer diameter of the entire electric machine assembly including the housing is not necessarily enlarged by the use of cooling conduits within the stator slots. It is thought that for most applications, the enlargement of the stator core and the reduction in the size of the housing will substantially offset each other with the use of in-slot cooling conduits providing an electric machine assembly having a substantially similar outer diameter as a similar water jacket cooled electric machine with either small enlargements or small reductions in diameter being possible.

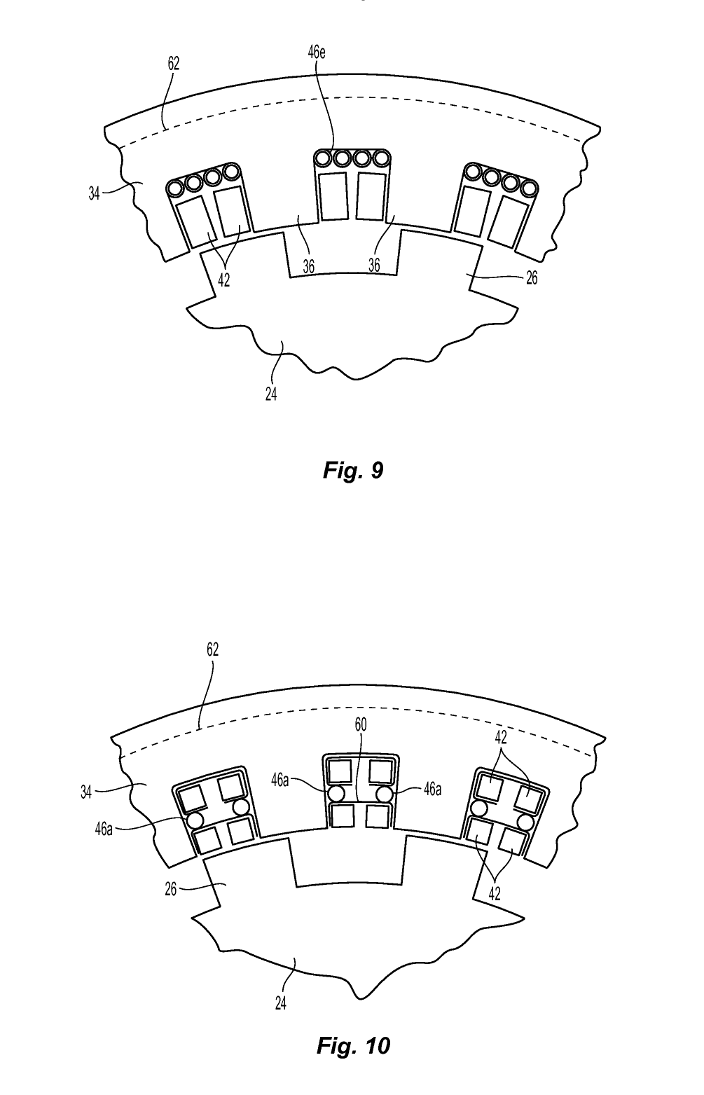

FIG. 9 represents an arrangement wherein the cooling conduit could have a configuration similar to either the conduit illustrated in either FIG. 6 or those illustrated in FIG. 7. In FIG. 9, the conduit is identified as the one illustrated in FIG. 6.

FIG. 10 represents an embodiment wherein the cooling conduit is positioned radially between windings 42.

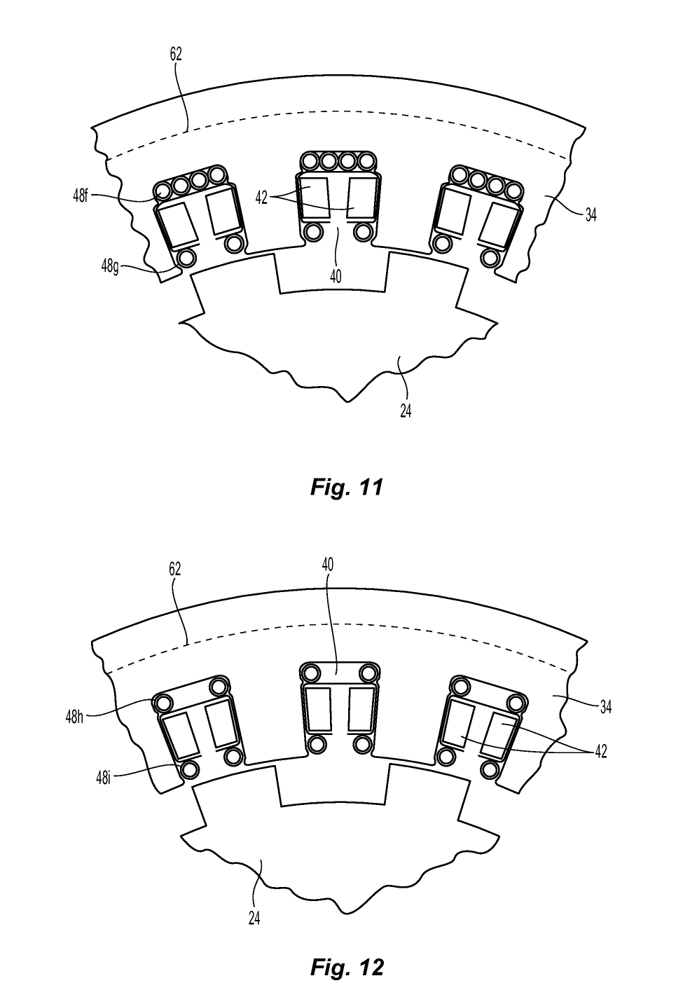

FIGS. 11 and 12 represent embodiments wherein two separate conduits are inserted into each slot 42 from opposite ends of slot 40 with one of the conduits being positioned radially outwardly of windings 42 and one of the conduits being positioned radially inwardly of windings 42. In FIG. 11, projecting bends 48f disposed radially outwardly of windings 42 have four axially extending legs or segments such as those illustrated in FIG. 6 while projecting bends 48g disposed radially inwardly of windings 42 have only two axially extending legs. In FIG. 12, projecting bends 48h disposed radially outwardly of windings 42 and projecting bends 48i located radially inwardly of windings 42 both have only two axially extending legs.

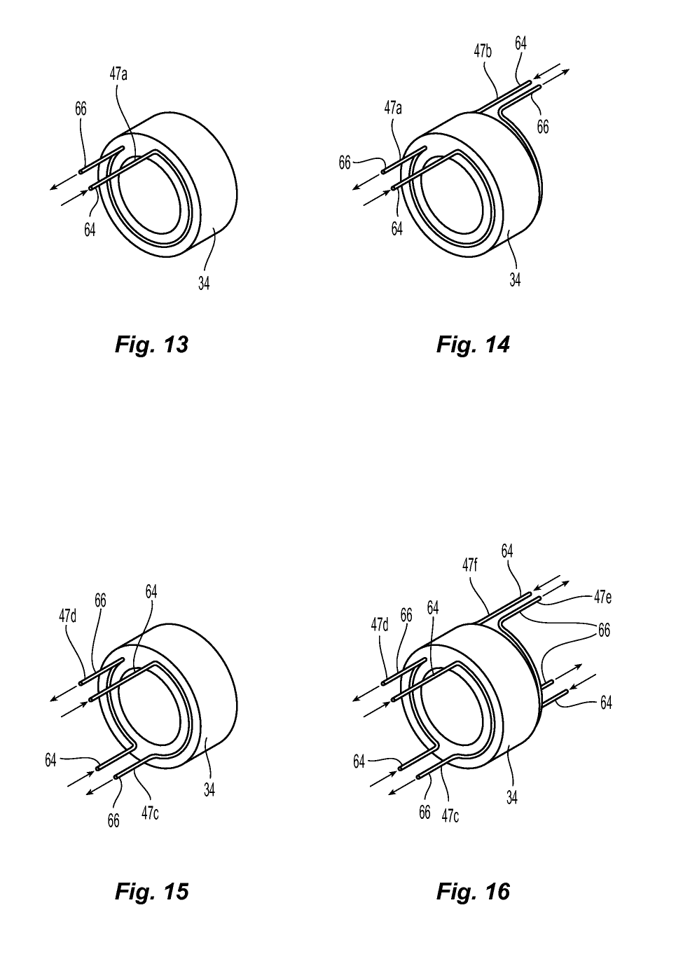

FIGS. 13-16 schematically represent several alternative overall cooling system flow patterns. FIGS. 13-16 have been graphically simplified to omit the individual projecting bends for each slot and are intended to show the overall flow pattern. The actual flow path for these figures would include portions that extend down into a slot and then return out of the slot as can be seen in FIGS. 4-7.

In FIG. 13, a single elongate conduit 47a is used to cool the electric machine. Conduit 47a includes an inlet 64 which receives a liquid coolant at a reduced temperature. After the coolant passes through each of the projecting bends, conduit 47a discharges the coolant back to the remainder of the cooling system through an outlet 66. The cooling system will then remove heat from that coolant that it picked up from the electric machine and return it to the inlet 64. The elongate conduits shown in FIGS. 4 and 6, as well as other alternative configurations, could be employed with the flow pattern depicted in FIG. 13.

FIG. 14 differs from FIG. 13 in that it includes two elongate conduits 47a, 47b which are located on opposite axial ends of stator core 34. The elongate conduits shown in FIGS. 5 and 7, as well as other alternative configurations, could be employed with the flow pattern depicted in FIG. 14.

FIG. 15 includes two elongate conduits 47c, 47d, however, they are both located on the same axial end of stator core 34 instead of being on opposite ends. In this configuration, each of the two elongate conduits 47c, 47d has a plurality of projecting bends that correspond to approximately half of the total number of stator slots 40. The elongate conduits shown in FIGS. 4 and 6, as well as other alternative configurations, could be employed with the flow pattern depicted in FIG. 15.

FIG. 16 includes four elongate conduits 47c, 47d, 47e, 47f with two elongate conduits being disposed on each axial end of the stator core 34. Similar to FIG. 15, each of the conduits of the configuration of FIG. 16 have a plurality of projecting bends that correspond to approximately half the total number of stator slots. Similar to FIG. 14, each of the slots 40 in the configuration of FIG. 16 have a conduit entering from each of its opposite axial end openings. The elongate conduits shown in FIGS. 5 and 7, as well as other alternative configurations, could be employed with the flow pattern depicted in FIG. 16.

With regard to FIGS. 14 and 16, the positioning of the inlets 64 and outlets 66 on the opposite axial ends of stator core 34 is worth noting. When employing conduits on opposite axial ends of the stator core, it will generally be desirable to have the coolant flow in opposite directions whereby the slot 40 which is positioned to receive the coolant immediately downstream of inlet 64 (and thus receive it at its lowest temperature) from the conduit on one axial end is positioned to receive the coolant immediately upstream of the outlet 66 (and thus receive it at a relatively elevated temperature) from the conduit on the opposite axial end. This arrangement seeks to equalize the heat removal from the different slots 40. Whether or not such equalization is sufficiently advantageous to warrant the use of multiple conduits will depend on the application and operating characteristics of the electric machine.

While this invention has been described as having an exemplary design, the present invention may be further modified within the spirit and scope of this disclosure. This application is therefore intended to cover any variations, uses, or adaptations of the invention using its general principles.

What is claimed is:

1. An electric machine comprising:
a rotor rotatable about an axis;
a stator operably coupled with the rotor, the stator comprising a stator core and at least one winding, the stator core defining at least one slot wherein the winding extends axially within the slot and wherein the slot defines a first axial end opening; and
an elongate cooling conduit adapted to convey a liquid coolant therein, the conduit having at least one projecting bend positioned in the at least one slot wherein the projecting bend has first and second axially extending legs and an intermediate section connecting the first and second legs, the first leg positioned to convey coolant into the slot through the first axial end opening, the coolant being sequentially conveyed within the projecting bend through the first leg, the intermediate section and then the second leg, the second leg conveying the coolant out of the slot through the first axial end opening and wherein the projecting bend is in thermal communication with at least one of the winding and the stator core.

2. The electric machine of claim 1 wherein the projecting bend is configured to be insertable into the slot through the first axial end opening.

3. The electric machine of claim 1 wherein the at least one slot defines a second axial end opening opposite the first axial end opening and the projecting bend extends axially within the slot to or beyond a location proximate the second axial end opening.

4. The electric machine of claim 1 wherein the at least one slot defines a second axial end opening opposite the first axial end opening and the electric machine further comprises a second elongate cooling conduit adapted to convey a liquid coolant therein, the second conduit having at least one opposing projecting bend positioned in the at least one slot wherein the opposing bend has third and fourth axially extending legs and a second intermediate section connecting the third and fourth legs, the third leg positioned to convey coolant into the slot through the second axial end opening, the coolant being sequentially conveyed within the opposing bend through the third leg, the intermediate section and then the fourth leg, the fourth leg conveying the coolant out of the slot through the second axial end opening wherein the opposing bend is in thermal communication with at least one of the winding and the stator core.

5. The electric machine of claim 4 wherein the projecting bend extends axially within the slot from the first axial end opening to proximate a midway point between the first and second axial end openings and the opposing projecting bend extends from the second axial end opening within the slot to proximate the midway point.

6. The electric machine of claim 4 wherein the projecting bend and the opposing projecting bend both extend within the slot for a distance substantially equivalent to the axial distance between the first and second axial end openings.

7. The electric machine of claim 1 wherein the projecting bend is displaced radially relative to the winding.

8. The electric machine of claim 1 wherein the conduit is secured relative to the stator core by engagement of the at least one projecting bend with the stator core.

9. The electric machine of claim 1 wherein intermediate section defines a pair of axially extending conduit segments.

10. The electric machine of claim 1 wherein the at least one slot defines a plurality of slots, each of the slots defining a first axial end opening and an opposite second axial end opening and wherein the at least one winding comprises a plurality of windings with at least one of the plurality of windings extending axially within each of the plurality of slots; and
wherein the elongate cooling conduit defines a plurality of projecting bends, each of the projecting bends having first and second axially extending legs and an intermediate section connecting the first and second legs, each of the projecting bends being disposed in a respective one of the plurality of slots wherein the first leg is positioned to convey coolant into the one slot through the first axial end opening, the coolant being sequentially conveyed within the projecting bend through the first leg, the intermediate section and then the second leg, the second leg conveying the coolant out of the one slot through the first axial end opening.

11. The electric machine of claim 10 wherein the elongate conduit forms a continuous electrical conductor.

12. The electric machine of claim 10 wherein the elongate conduit forming the plurality of projecting bends is a unitary length of conduit having a substantially uniform wall thickness and substantially uniform circumferential dimensions.

13. An electric machine comprising:
a rotor rotatable about an axis;
a stator operably coupled with the rotor, the stator including a stator core which is formed out of a stacked plurality of sheet metal laminations and defines a plurality of slots, each of the slots having an axial length and first and second axial end openings located at opposite axial ends of the slot; the stator further including a plurality of windings wherein at least one of the plurality of windings extends axially within each of the plurality of slots; and
an elongate cooling conduit adapted to convey a liquid coolant therein, the conduit defining a plurality of projecting bends, each of the projecting bends having first and second axially extending and substantially parallel legs and an intermediate section connecting the first and second legs, each of the projecting bends being disposed in a respective one of the plurality of slots wherein the first leg is positioned to convey coolant into the one slot through the first axial end opening, the coolant being sequentially conveyed within the projecting bend through the first leg, the intermediate section and then the second leg, the second leg conveying the coolant out of the one slot through the first axial end opening, wherein the projecting bend is positioned radially adjacent the at least one winding disposed in the slot and wherein the projecting bend is in thermal communication with at least one of the stator core and the at least one winding disposed in the slot; and
wherein the elongate conduit forming the plurality of projecting bends is a unitary length of conduit having a substantially uniform wall thickness and substantially uniform circumferential dimensions.

14. The electric machine of claim 13 wherein the plurality of projecting bends are configured to be simultaneously and respectively insertable into the plurality of slots through the first axial end openings of the slots.

15. The electric machine of claim 13 further comprising a second elongate cooling conduit adapted to convey a liquid coolant therein, the second conduit having a plurality of opposing projecting bends each of which is positioned in a respective one of the plurality of slots wherein each of the opposing bends has third and fourth axially extending legs and a second intermediate section connecting the third and fourth legs, the third leg positioned to convey coolant into the slot through the second axial end opening, the coolant being sequentially conveyed within the opposing bend through the third leg, the intermediate section and then the fourth leg, the fourth leg conveying the coolant out of the slot through the second axial end opening wherein the opposing bend is in thermal communication with at least one of the stator core and the least one of the winding disposed in the slot.

16. The electric machine of claim 13 wherein the conduit is secured relative to the stator core by engagement of the plurality of projecting bends with the stator core.

17. A method of manufacturing an electric machine, the method comprising:
providing a stator core with a plurality of slots;
providing a plurality of windings and installing at least one winding in each of the plurality of slots;
forming a plurality of projecting bends in an elongate conduit and positioning each of the projecting bends in one of the plurality of slots wherein each projecting bend has first and second axially extending and substantially parallel legs and an intermediate section connecting the first and second legs, the first leg positioned to convey coolant into the slot proximate a first axial end of the stator core, the coolant being sequentially conveyed within the projecting bend through the first leg, the intermediate section and then the second leg, the second leg conveying the coolant out of the slot proximate the first axial end of the stator core and wherein the projecting bend is in thermal communication with at least one of the winding and the stator core; and
operably coupling the stator assembly with a rotor assembly.

18. The method of claim 17 wherein the step of forming a plurality of projecting bends in an elongate conduit comprises providing a continuous and unitary conduit having a uniform wall thickness and uniform cross-sectional shape and bending the conduit to form the plurality of projecting bends.

19. The method of claim 17 wherein the step of positioning each of the projecting bends in one of the plurality of slots comprises simultaneously inserting each of the projecting bends into a respective one of the plurality of slots from the first axial end of the stator core.

20. The method of claim 17 wherein the step of positioning each of the projecting bends in one of the plurality of slots comprises securing the elongate conduit to the stator core by engaging the projecting bends with the stator core.
